(19) United States
(12) Patent Application Publication
(10) Pub. No.: US 2015/0066576 A1
(43) Pub. Date: Mar. 5, 2015

(54) Collaborative Audit Management System

(71) Applicants: Rico Modess, Shanghai (CN); Alexander Rodde, Hambruecken (DE)

(72) Inventors: Rico Modess, Shanghai (CN); Alexander Rodde, Hambruecken (DE)

(73) Assignee: SAP AG, Walldorf (DE)

(21) Appl. No.: 14/019,077

(22) Filed: Sep. 5, 2013

(51) Int. Cl. G06Q 10/06

(52) U.S. Cl. CPC G06Q 10/0635
USPC 705/7.28

(57) ABSTRACT

A method includes recording audit results from an audit being conducted on a computer searchable storage device, recording supporting documentation on the computer searchable storage device, searching the storage device for similar prior audits to reveal fraud patterns utilizing a database search engine, and correlating the fraud patterns with the audit being conducted.

### BACKGROUND

Audits are performed in many organizations to ensure that processes are being followed and to detect potential fraud. Some prior systems facilitated uploading of documents created during an audit to a shared folder, allowing others to access data. Such systems may have included a manual menu driven list based approach to supporting auditing activities, and were usually very slow.

### SUMMARY

A method includes recording audit results from an audit being conducted on a computer searchable storage device, recording supporting documentation on the computer searchable storage device, searching the storage device for similar prior audits to reveal fraud patterns utilizing a database search engine, and correlating the fraud patterns with the audit being conducted.

A computer readable storage device has code for causing a computer to execute a method. The method includes recording audit results from an audit being conducted on a computer searchable storage device, recording supporting documentation on the computer searchable storage device, searching the storage device for similar prior audits to reveal fraud patterns utilizing a database search engine, and correlating the fraud patterns with the audit being conducted.

A system includes a processor, a database system, a communications port to send and receive communications to and from auditing devices, and a storage device containing processor executable code to cause the processor to perform a method. The method includes recording audit results from an audit being conducted on the database system, recording supporting documentation on the database system, searching the database system for similar prior audits to reveal fraud patterns utilizing a database system search engine, and correlating the fraud patterns with the audit being conducted.

### BRIEF DESCRIPTION OF THE DRAWINGS

FIG. 1 is a block diagram of a collaborative audit system according to an example embodiment.

FIG. 2 is a block diagram illustrating audit data, including unstructured data according to an example embodiment.

FIG. 3 is an illustration of an audit road map according to an example embodiment.

FIG. 4 is a flowchart illustrating an audit process using a collaborative audit system according to an example embodiment.

FIG. 5 is a representation of a user interface for relationship management for a collaborative audit system according to an example embodiment.

FIG. 6 is a representation of a user interface showing a list of identified risks for a collaborative audit system according to an example embodiment.

FIG. 7 is a representation of a user interface showing an identified audit candidate with a list of risks for the audit candidate according to an example embodiment.

FIG. 8 is a representation of a user interface illustrating an audit plan forecast and audit plan inventory for a collaborative audit system according to an example embodiment.

FIG. 9 is a representation of a user interface for managing a review of a selected audit candidate for a collaborative audit system according to an example embodiment.

FIG. 10 is a representation of a user interface for a work package for a collaborative audit system according to an example embodiment.

FIG. 11 is a representation of a user interface illustrating audit analytics according to an example embodiment.

FIG. 12 is a block diagram of a computer system for implementing one or more devices for a collaborative audit system according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

An audit system and method includes central data storage having a data model covering an end-to-end audit process. The data model includes supporting documentation, such as interview transcripts, emails, photographs, and other information utilized during an audit to reach conclusions. The audit system further includes social and collaborative elements, mobile devices to facilitate mobile reporting and audit work, and an unstructured data search to re-use information, including supporting documentation from prior similar audits. The prior audit information may be used to facilitate identification and investigation of potential fraud situations by allowing quick identification and review of supporting documentation in similar fraud situations. In some embodiments, the central data storage may include a cloud based in memory database having analytic capabilities.

Unstructured data refers to information that either does not have a pre-defined data model, or does not fit well into relational tables. It may include text, numbers, facts, photographs, and other forms of information. An unstructured data search may involve different data mining techniques, such as text analytics and noisy text analytics to name a few. An unstructured information management architecture (UIMA) may be used in some embodiments to provide a common framework for processing unstructured information to extract meaning and provide some form of structure to unstructured data.

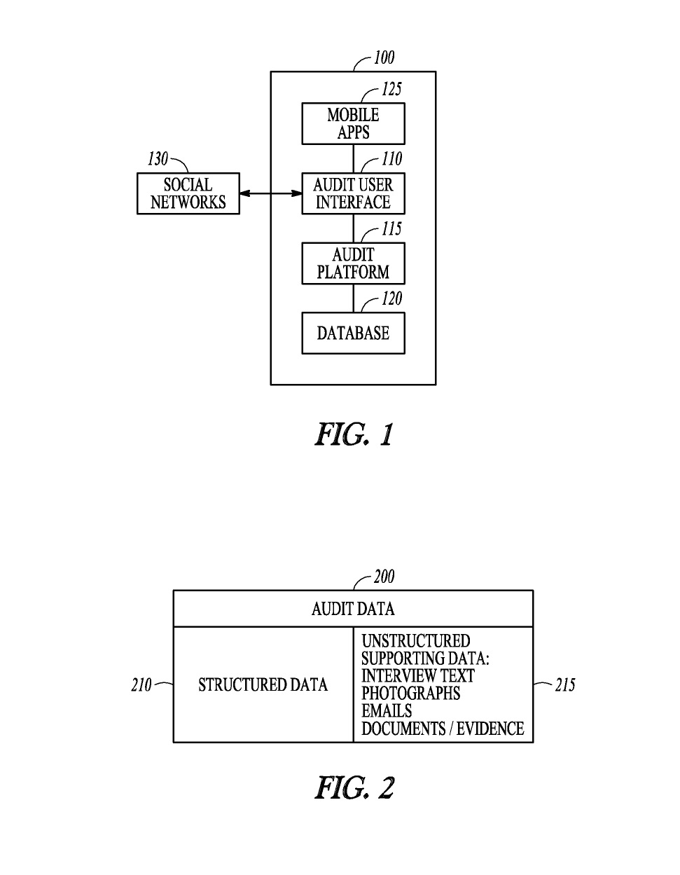

FIG. 1 is a block diagram of a collaborative audit system 100 according to an example embodiment. Audit system 100 includes an audit user interface 110 running on an audit platform 115 such as a governance risk and compliance product by SAP. A database 120 provides a searchable storage space for both structured and unstructured data. In one embodiment, an in memory database product, such as SAP HANA provides search capabilities for fraud management and detection. Mobile applications are provided at 125, and a connection to social networks 130, such as LinkedIn, Facebook, Twitter, Jam and others provides easy mechanisms to collect collaborative input from which to assess risk areas that might need auditing.

In one embodiment, system 100 provides stakeholder relationship management, allowing the tracking of relationships and interests that might be relevant to performing an audit. Audit planning is integrated into the system, along with flexible audit universe and risk assessment logic. A capacity calculation methodology may also be provided. Workpaper management is provided via drag and drop capabilities, automated referencing of working papers, unstructured data searching, and embedded collaborative audit documentation tools such as process flow and timeline of events.

Mobile audit tools via mobile devices include interview recording, taking photographs, collaboration on audit issues with colleagues, unstructured data searching, automatic voice transcripts and mobile integrated document management. Fraud management functions include industry specific data queries on live data and deployment of customized queries and analytics, such as via the in memory database 120 capabilities.

FIG. 2 is a block diagram illustrating audit data 200, including structured data indicated at 210 and unstructured data 215 according to an example embodiment. The structured data 210 may include data that is common to many audits, such as dates, locations, people, and other sorts of data commonly stored in relational databases for various applications. The unstructured data may include many different types of data that supports an audit, such as interview text, photographs, emails, documents, and other types of evidence that may vary between different types of audits.

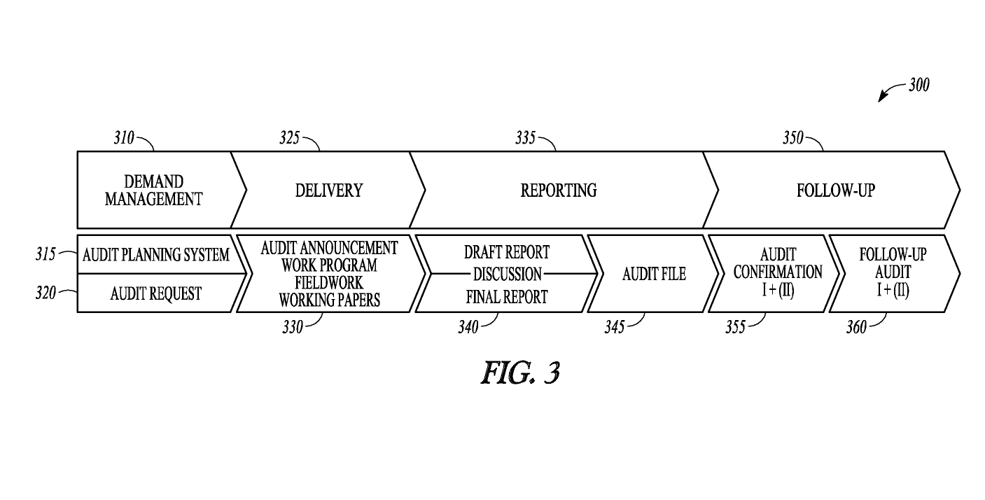

FIG. 3 is an illustration of an audit road map 300 according to an example embodiment. Audits may be driven by many different sources. Demand management 310 is used to keep track of potential audits, and may include an audit planning system 315 and an audit request 320. Some audits may be performed on a periodic basis, and planned well out into the future. Others may be initiated based on management requests or various tips that may be received via phone, email, letter, social media, or other sources.

Based on the demand management 310, delivery 325 includes as identified at 330, audit announcement, work program, field work, and working papers. Audits then result in reporting 335, including a draft report, discussion, and final report 340. An audit file 345 is also created. Follow-up may occur as indicated at 350 with an audit confirmation 355 and follow-up audit 360.

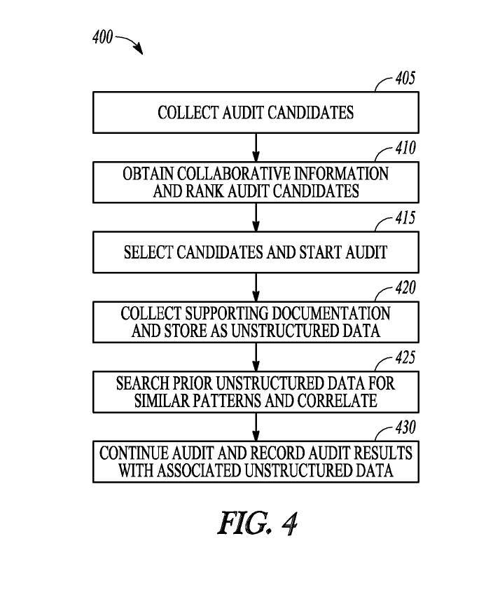

FIG. 4 is a flowchart illustrating an audit process 400 using a collaborative audit system according to an example embodiment. At 405, audit candidates are collected, usually from multiple different sources as described above. Information is collected at 410 from many different collaborative sources, and the candidates are ranked. At 415, candidates are selected, and auditing activities are started. Supporting documentation is generated and collected at 420. Some of the supporting documentation is stored as unstructured data. As mentioned, the unstructured data may be text, and may also include photographs. Such supporting data may be collected via mobile devices and from collaborative sources in various embodiments.

At 425, prior unstructured data may be searched for similar patterns and correlated with the unstructured supporting documentation. Such data can be very helpful in conducting an audit. For instance, a pattern may be found in one or more audits previously conducted. These previous audits may then be reviewed to see how they were handled, what methods were used to collect data and what data was indicative of risk. The ability to search the unstructured data can enhance the audit process and provides the ability to ensure best practices among auditors can be utilized. Further, collaboration is facilitated, as an auditor can discuss previous audits with the auditors and others involved in such audits. At 430, the audit continues with this enhanced information, the results and supporting documentation are recorded such that they are available to learn from for future audits. In addition, since the supporting documentation is captured at the time of the audit as opposed to recreated from likely modified documentation over time, it is much easier to review the audit at later time since the contemporary evidence is stored with audit information.

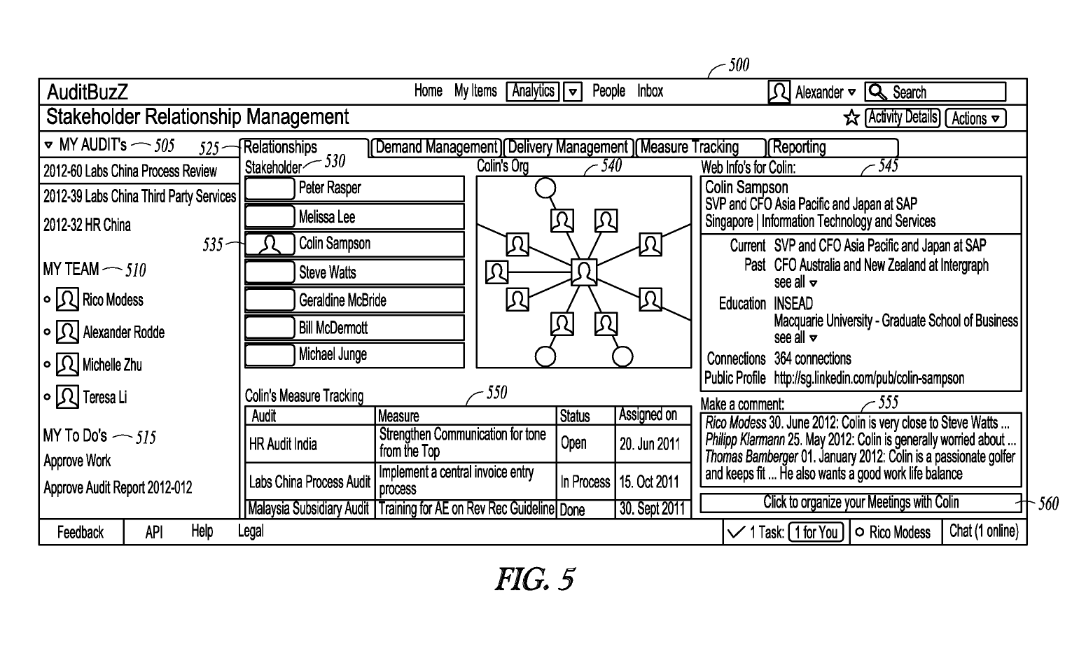

FIG. 5 is a representation of a user interface 500 for relationship management for a collaborative audit system according to an example embodiment. Interface 500 is an auditor specific interface, illustrating the auditor's audits at 505, team members at 510 and list of to do's at 515. A specific audit is shown as selected at 520, and a relationships tab 525 is shown as selected, resulting in a list of stakeholders 530 from which one person, Collin, is selected at 535. Collin's organization is shown at 540, and information about Collin collected from various sources, such as the web, is shown at 545. A measure tracking section 550 shows other audits involving Collin along with status. A comments section 555 illustrates comments that others have provided regarding Collin. A button 560 is also provided to organize meetings with Collin regarding the various audits he is associated with.

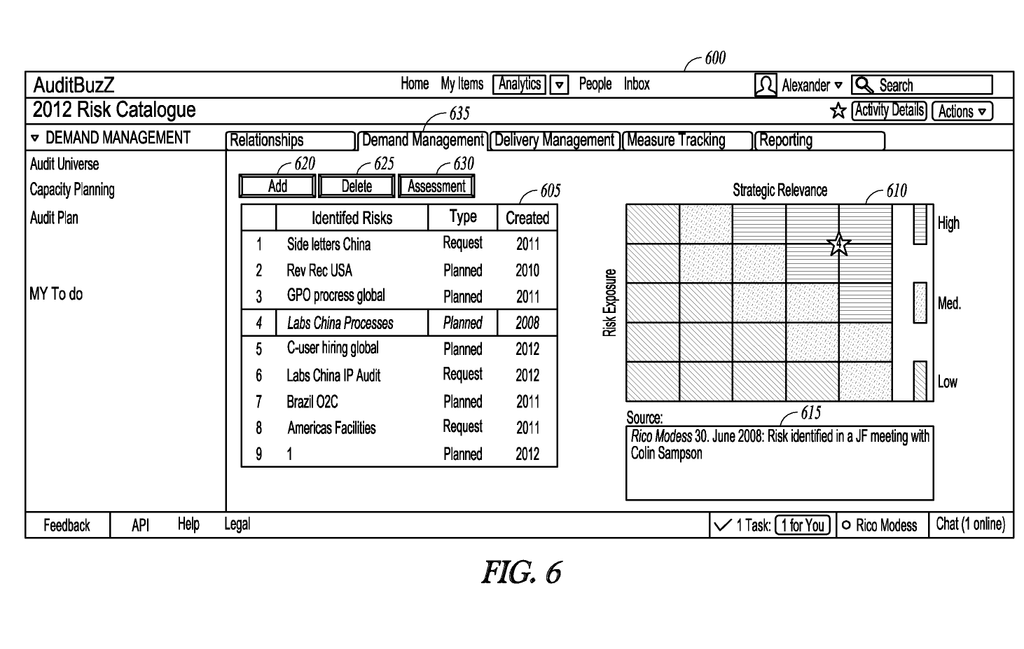

FIG. 6 is a representation of a user interface 600 showing a list 605 of identified risks for a collaborative audit system according to an example embodiment. A chart 610 shows a risk exposure as a function of strategic relevance, ranked low, medium, and high. A source section 615 provides information regarding the source of the risk identification. Buttons are also provided to add 620, delete 625, and provide assessments 630 for each identified risk. This interface results from selection of a demand management tab 636.

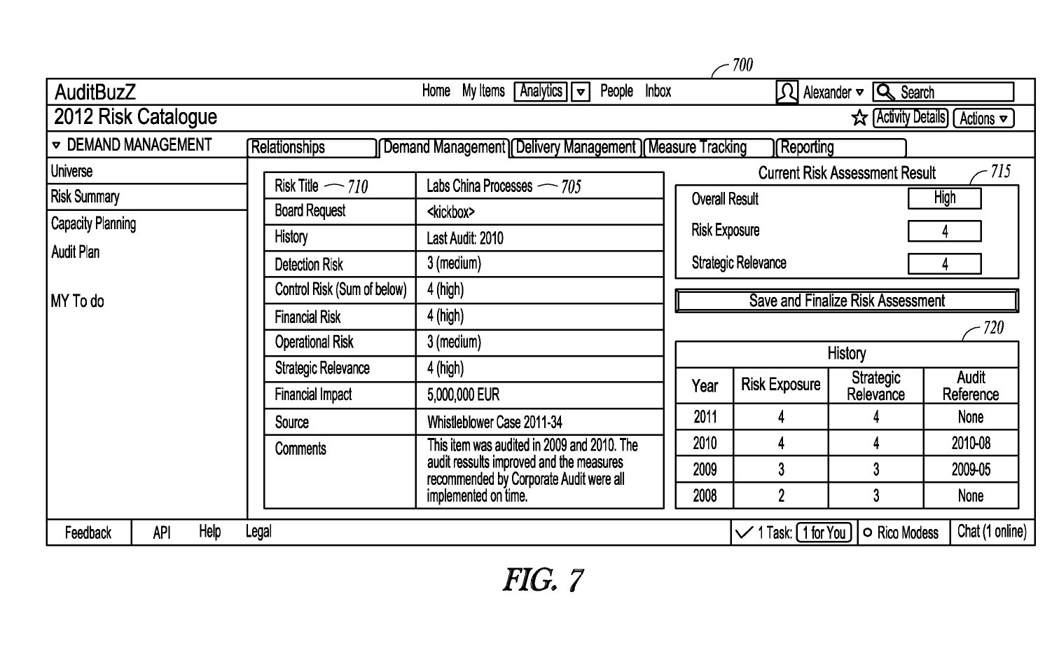

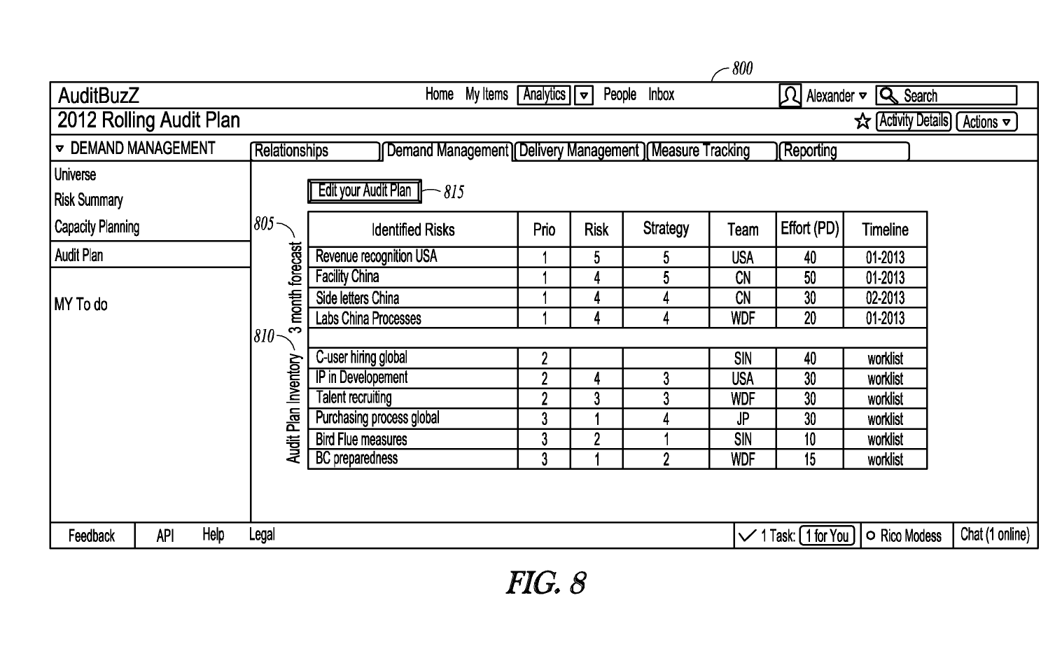

FIG. 7 is a representation of a user interface 700 showing an identified audit candidate, Labs China Processes 705, with a list of risks 710 for the audit candidate according to an example embodiment. Each risk is associated with an exposure estimate, which may vary from a subjective assessment of low, medium, or high, or actual monetary assessment. Comments may also be provided. A risk assessment result may also be included at 715, as well as a history of audits at 720.

FIG. 8 is a representation of a user interface 800 illustrating an identified risks audit plan three month forecast 805 and audit plan inventory 810 for a collaborative audit system according to an example embodiment. The risks may include a priority, risk level, strategy indicator, team identifier, amount of effort indication and timeline in various embodiments. A button may be provided at 815 to allow editing the audit plan.

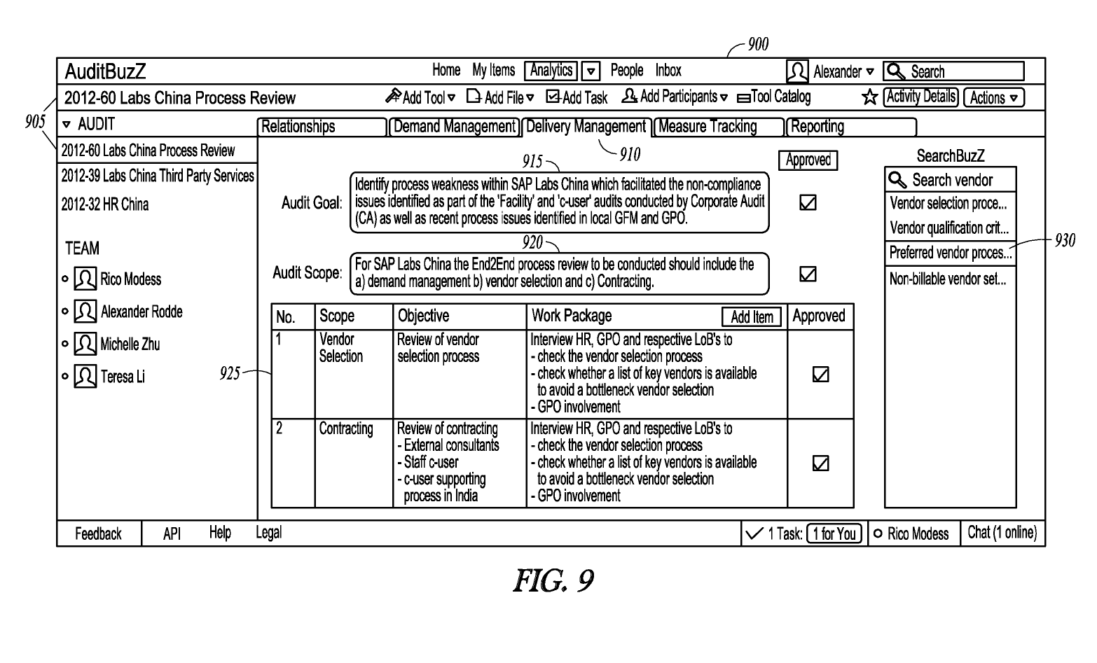

FIG. 9 is a representation of a user interface 900 for managing a review of a selected audit candidate 905 for a collaborative audit system according to an example embodiment. Under a delivery management tab 910, a text based audit goal 915 and audit scope 920 may be identified. These are examples of unstructured data in one embodiment. Further unstructured data is shown at 925 which illustrates a scope of audit activities with corresponding objectives and work items or packages. A checkbox is provided for each activity for indicating whether the activity is approved or not. At 930, a list of queries is provided for searching prior audits. In this case, a preferred vendor process is selected for searching.

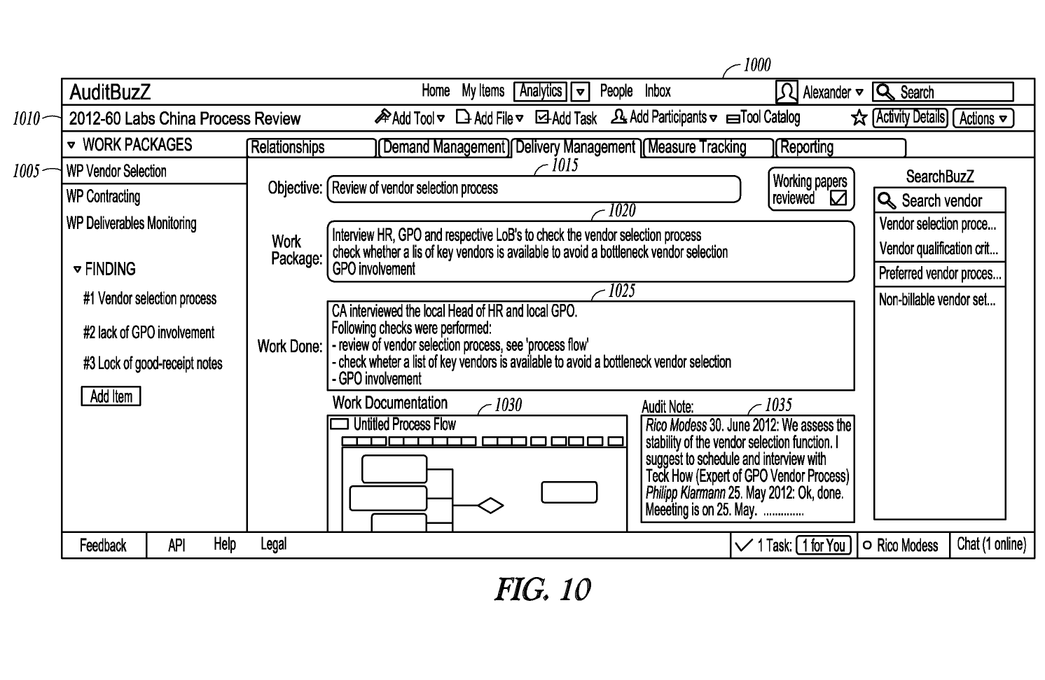

FIG. 10 is a representation of a user interface 1000 for a work package, WP Vendor Selection at 1005 for a selected audit 1010 according to an example embodiment. An objective is provided at 1015 along with a description of a work package consisting of tasks at 1020. Work done is illustrated at 1025 and supporting documentation is illustrated at 1030, in this case, an unstructured flow diagram. Audit notes 1035 may also be provided as unstructured data.

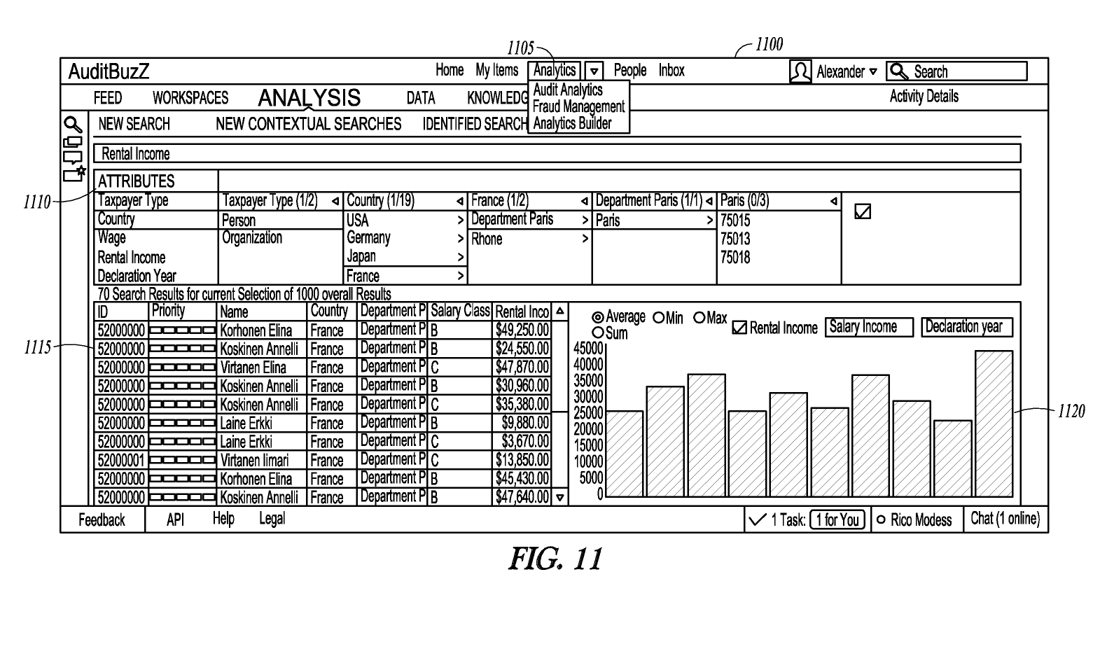

FIG. 11 is a representation of a user interface 1100 illustrating audit analytics 1105 according to an example embodiment. A number of attributes 1110 for a search may be selected. In this case, rental income for named persons is shown at 1115 and in bar chart form at 1120. This information may be used for fraud analysis and may be based on real time data given the in memory database capabilities.

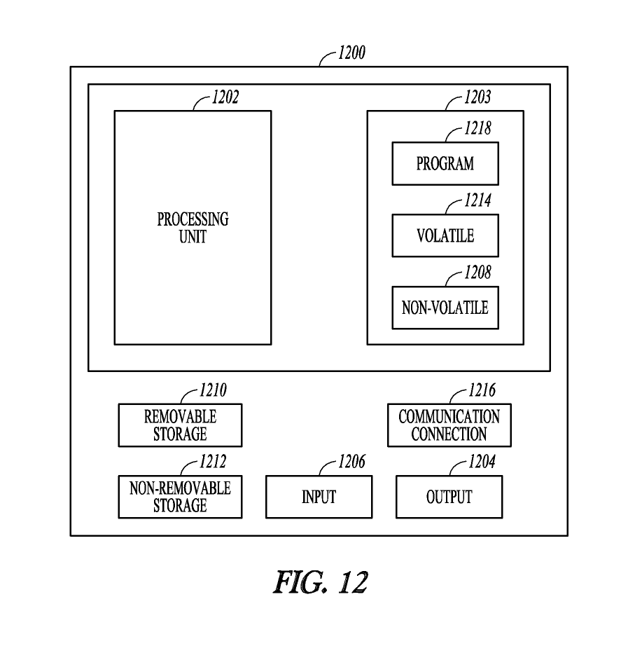

FIG. 12 is a block diagram of a computer system 1200 for implementing one or more devices for a collaborative audit system according to an example embodiment. In one embodiment, multiple such computer systems are utilized in a distributed network to implement multiple components in a transaction based environment. Mobile devices such as a laptop computers, tablets and smart phones may also be included to facilitate collaboration with the audit system. An object-oriented, service-oriented, or other architecture may be used to implement such functions and communicate between the multiple systems and components. One example computing device in the form of a computer 1200, may include a processing unit 1202, memory 1203, removable storage 1210, and non-removable storage 1212. Memory 1203 may include volatile memory 1214 and non-volatile memory 1208. Computer 1200 may include—or have access to a computing environment that includes—a variety of computer-readable media, such as volatile memory 1214 and non-volatile memory 1208, removable storage 1210 and non-removable storage 1212. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1200 may include or have access to a computing environment that includes input 1206, output 1204, and a communication connection 1216. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 1202 of the computer 1200. A hard drive, CD-ROM, and RAM are some examples of articles including a non-transitory computer-readable medium. For example, a computer program 1218 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 1200 to provide generic access controls in a COM based computer network system having multiple users and servers.

### Examples

1. A method comprising:

recording audit results from an audit being conducted on a computer searchable storage device;

recording supporting documentation on the computer searchable storage device;

searching the storage device for similar prior audits to reveal fraud patterns utilizing a database search engine; and correlating the fraud patterns with the audit being conducted.

2. The method of example 1 wherein the supporting documentation includes text documenting discussions with people interviewed during the audit.

3. The method of any of examples 1-2 wherein the supporting documentation includes emails collected during the audit.

4. The method of example 3 wherein the emails are used to prioritize audit candidates prior to authorizing an audit.

5. The method of any of examples 1-4 wherein the supporting documentation includes third party comments regarding persons responsible for an area being audited.

6. The method of any of examples 1-5 wherein the searching comprises an unstructured search of both the audit results and supporting documentation.

7. The method of example 6 wherein the database search engine also performs the correlation of the fraud patterns.

8. The method of any of examples 6-7 wherein the storage device stores the audit results and supporting documentation in an in memory database.

9. The method of any of examples 1-8 wherein the supporting documentation includes mobile device originated photographs.

10. A computer readable storage device having code for causing a computer to execute a method, the method comprising:

recording audit results from an audit being conducted on a computer searchable storage device;

recording supporting documentation on the computer searchable storage device;

searching the storage device for similar prior audits to reveal fraud patterns utilizing a database search engine; and correlating the fraud patterns with the audit being conducted.

11. The computer readable storage device of example 10 wherein the supporting documentation includes emails and photographs collected during the audit.

12. The computer readable storage device of example 11 wherein the emails are used to prioritize audit candidates prior to authorizing an audit.

13. The computer readable storage device of any of examples 10-12 wherein the searching comprises an unstructured search of both the audit results and supporting documentation.

14. The computer readable storage device of example 13 wherein the database search engine also performs the correlation of the fraud patterns.

15. The computer readable storage device of any of examples 13-14 wherein the storage device stores the audit results and supporting documentation in an in memory database.

16. A system comprising:

a processor;

a database system;

a communications port to send and receive communications to and from auditing devices; and

a storage device containing processor executable code to cause the processor to perform a method, the method comprising:

recording audit results from an audit being conducted on the database system;

recording supporting documentation on the database system;

searching the database system for similar prior audits to reveal fraud patterns utilizing a database system search engine; and

correlating the fraud patterns with the audit being conducted.

17. The system of example 16 wherein the supporting documentation includes text documenting discussions with people interviewed during the audit.

18. The system of any of examples 16-17 wherein the supporting documentation includes emails and photographs collected during the audit.

19. The system any of examples 16-18 wherein the searching comprises an unstructured search of both the audit results and supporting documentation.

20. The method of example 19 wherein the database system comprises an in memory database including analytic capabilities.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
recording audit results from an audit being conducted on a computer searchable storage device;
recording supporting documentation on the computer searchable storage device;
searching the storage device for similar prior audits to reveal fraud patterns utilizing a database search engine; and
correlating the fraud patterns with the audit being conducted.

2. The method of claim 1 wherein the supporting documentation includes text documenting discussions with people interviewed during the audit.

3. The method of claim 1 wherein the supporting documentation includes emails collected during the audit.

4. The method of claim 3 wherein the emails are used to prioritize audit candidates prior to authorizing an audit.

5. The method of claim 1 wherein the supporting documentation includes third party comments regarding persons responsible for an area being audited.

6. The method of claim 1 wherein the searching comprises an unstructured search of both the audit results and supporting documentation.

7. The method of claim 6 wherein the database search engine also performs the correlation of the fraud patterns.

8. The method of claim 6 wherein the storage device stores the audit results and supporting documentation in an in memory database.

9. The method of claim 1 wherein the supporting documentation includes mobile device originated photographs.

10. A computer readable storage device having code for causing a computer to execute a method, the method comprising:
recording audit results from an audit being conducted on a computer searchable storage device;
recording supporting documentation on the computer searchable storage device;
searching the storage device for similar prior audits to reveal fraud patterns utilizing a database search engine; and
correlating the fraud patterns with the audit being conducted.

11. The computer readable storage device of claim 10 wherein the supporting documentation includes emails and photographs collected during the audit.

12. The computer readable storage device of claim 11 wherein the emails are used to prioritize audit candidates prior to authorizing an audit.

13. The computer readable storage device of claim 10 wherein the searching comprises an unstructured search of both the audit results and supporting documentation.

14. The computer readable storage device of claim 13 wherein the database search engine also performs the correlation of the fraud patterns.

15. The computer readable storage device of claim 13 wherein the storage device stores the audit results and supporting documentation in an in memory database.

16. A system comprising:
a processor;
a database system;
a communications port to send and receive communications to and from auditing devices; and
a storage device containing processor executable code to cause the processor to perform a method, the method comprising:
recording audit results from an audit being conducted on the database system;
recording supporting documentation on the database system;
searching the database system for similar prior audits to reveal fraud patterns utilizing a database system search engine; and
correlating the fraud patterns with the audit being conducted.

17. The system of claim 16 wherein the supporting documentation includes text documenting discussions with people interviewed during the audit.

18. The system of claim 16 wherein the supporting documentation includes emails and photographs collected during the audit.

19. The system claim 16 wherein the searching comprises an unstructured search of both the audit results and supporting documentation.

20. The method of claim 19 wherein the database system comprises an in memory database including analytic capabilities.
